(19) United States
(12) Patent Application Publication
(10) Pub. No.: US 2021/0074299 A1
(43) Pub. Date: Mar. 11, 2021

(54) ELECTRONIC APPARATUS FOR SELECTING AI ASSISTANT AND RESPONSE PROVIDING METHOD THEREOF

(71) Applicant: SAMSUNG ELECTRONICS CO., LTD., Suwon-si (KR)

(72) Inventors: Inchul Hwang, Suwon-si (KR); Donghyeon Lee, Suwon-si (KR); Hyeonmok Ko, Suwon-si (KR); Seonghan Ryu, Suwon-si (KR); Kyenghun Lee, Suwon-si (KR); Eunji Lee, Suwon-si (KR); Jongsun Lee, Suwon-si (KR); Yongjin Cho, Suwon-si (KR); Sungja Choi, Suwon-si (KR)

(73) Assignee: SAMSUNG ELECTRONICS CO., LTD., Suwon-si (KR)

(21) Appl. No.: 17/015,788

(22) Filed: Sep. 9, 2020

(30) Foreign Application Priority Data
Sep. 10, 2019 (KR) 10-2019-0112039

(51) Int. Cl. G10L 15/32; G06F 9/451; G06F 16/9032; G10L 15/22

(52) U.S. Cl. CPC G10L 15/32; G10L 15/22; G06F 16/90332; G06F 9/453

(57) ABSTRACT

An electronic apparatus is provided. The electronic apparatus includes a memory storing information regarding a plurality of voice assistants, and a processor. The processor may be configured to, based on a voice of a user being input via a microphone, identify a voice assistant among the plurality of voice assistants based on the user's voice, and identify whether the identified voice assistant is able to provide a response to the voice, by inputting a text converted from the user's voice to an artificial intelligence model trained based on texts recognizable by the identified voice assistant, based on the identified voice assistant being identified to be unable to provide a response to the voice, obtain a response to the voice from at least one of the plurality of voice assistants other than the identified voice assistant, and output at least one of the plurality of obtained responses as a response to the voice.

### CROSS-REFERENCE TO RELATED APPLICATION(S)

This application is based on and claims priority under 35 U. S.C. § 119 to Korean Patent Application No. 10-2019-0112039, filed on Sep. 10, 2019, in the Korean Intellectual Property Office, the disclosure of which is incorporated by reference herein in its entirety.

### BACKGROUND

### 1. Field

The disclosure relates to an electronic apparatus for providing a response to a user's voice using one or more of a plurality of artificial intelligence (AI) voice assistants, and more particularly to an electronic apparatus for verifying one or more responses obtained from one or more voice assistants, based on a response to a user's voice being unable to be provided through a voice assistant selected by a user.

### 2. Description of Related Art

In the related art, various artificial intelligence voice assistants such as Alexa, Google Assistant, Cortana, Bixby, and the like have been developed and used.

However, in a case of using only a certain voice assistant, it is possible to receive a high-quality service from the voice assistant regarding a service category in which the voice assistant provides a comparatively more excellent service than other voice assistants. However, it is difficult to expect a high-quality service regarding a service category in which the assistant provides a comparatively inferior service.

In addition, a voice assistant preferred for each user may be different.

Accordingly, it is necessary to suitably use a plurality of voice assistants by considering categories and/or users.

### SUMMARY

In accordance with an aspect of the disclosure, there is provided an electronic apparatus including: a memory configured to store information regarding a plurality of voice assistants; and a processor configured to: based on a voice of a user being input via a microphone, identify a voice assistant among the plurality of voice assistants based on the input voice; identify whether the identified voice assistant is able to provide a response to the input voice, by inputting a text converted from the input voice to an artificial intelligence (AI) model trained based on texts recognizable by the identified voice assistant; based on the identified voice assistant being identified to be unable to provide a response to the input voice, obtain a response to the input voice from at least one of the plurality of voice assistants other than the identified voice assistant; and provide at least one of a plurality of obtained responses as a response to the input voice.

The processor may be further configured to, based on the text converted from the input voice including a trigger word for activating the voice assistant among the plurality of voice assistants, identify the voice assistant corresponding to the trigger word.

The memory may be further configured to store information regarding the voice assistant for each of a plurality of domains, and the processor may be further configured to: identify a domain corresponding to the input voice by inputting the text converted from the input voice to an artificial intelligence model trained to determine a domain of an input text among the plurality of domains; and identify the voice assistant corresponding to the identified domain among the plurality of voice assistants based on the information stored in the memory.

The processor may be further configured to, based on the identified voice assistant being identified to be able to provide a response to the input voice, provide a response to the input voice using the identified voice assistant.

The processor may be further configured to: based on the identified voice assistant being identified to be unable to provide a response to the input voice, identify whether another voice assistant is able to provide a response to the input voice, by inputting the text converted from the input voice to another artificial intelligence model that has been trained based on texts recognizable by the other voice assistant among the plurality of voice assistants; and based on the other voice assistant being identified to be unable to provide a response to the input voice, obtain a response to the input voice from each of the plurality of voice assistants.

The processor may be further configured to: based on the identified voice assistant being identified to be unable to provide a response to the input voice, identify a voice assistant which is able to provide a response to the input voice, from among the plurality of voice assistants, by inputting the text converted from the input voice to an artificial intelligence model that is trained based on texts recognizable by the plurality of voice assistants; and based on none of the plurality of voice assistants being identified to be able to provide a response to the input voice, obtain a response to the input voice from each of the plurality of voice assistants.

The processor may be further configured to: identify an accuracy of a response of each voice assistant to the input voice by inputting the response obtained from each of the plurality of voice assistants to an artificial intelligence model trained based on a plurality of questions-responses; and provide a response to the input voice through at least one of the plurality of voice assistants based on the identified accuracy.

The processor may be further configured to provide a response of the identified voice assistant which provided a response with a highest accuracy among the plurality of voice assistants as a response to the input voice.

The processor may be further configured to, based on the accuracy of the response of each of the plurality of voice assistants being within a predetermined range, provide a response to the input voice by combining the responses of the plurality of voice assistants.

The processor may be further configured to: determine the text converted from the input voice as a text recognizable by a voice assistant which provided a response with a highest accuracy; and update an artificial intelligence model trained based on texts recognizable by the voice assistant based on the determined text.

According to an aspect of the disclosure, there is provided response providing method of an electronic apparatus, the response providing method including: based on a voice of a user being input via a microphone, identifying a voice assistant among a plurality of voice assistants based on the input voice; identifying whether the identified voice assistant is able to provide a response to the input voice, by inputting a text converted from the input voice to an artificial intelligence model trained based on texts recognizable by the identified voice assistant; based on the identified voice assistant being identified to be unable to provide a response to the input voice, obtaining a response to the input voice from at least one of the plurality of voice assistants other than the identified voice assistant; and providing at least one of a plurality of obtained responses as a response to the input voice.

The identifying the voice assistant may include, based on the text converted from the input voice including a trigger word for activating the voice assistant among the plurality of voice assistants, identifying the voice assistant corresponding to the trigger word.

The identifying the voice assistant may include: identifying a domain corresponding to the input voice by inputting the text converted from the input voice to an artificial intelligence model trained to determine a domain of an input text among a plurality of domains; and identifying the voice assistant corresponding to the identified domain among the plurality of voice assistants.

The response providing method may further include, based on the identified voice assistant being identified to be able to provide a response to the input voice, providing a response to the input voice using the identified voice assistant.

The response providing method may further include, based on the identified voice assistant being identified to be unable to provide a response to the input voice, identifying whether another voice assistant is able to provide a response to the input voice, by inputting the text converted from the input voice to an artificial intelligence model trained based on texts recognizable by the other voice assistant among the plurality of voice assistants, and the obtaining a response may include, based on the other voice assistant being identified to be unable to provide a response to the input voice, obtaining a response to the input voice from each of the plurality of voice assistants.

The response providing method may further include, based on the identified voice assistant being identified to be unable to provide a response to the input voice, identifying a voice assistant which is able to provide a response to the input voice among the plurality of voice assistants by inputting the text converted from the input voice to an artificial intelligence model trained based on texts recognizable by the plurality of voice assistants, and the obtaining a response may include, based on none of the plurality of voice assistants being identified to be able to provide a response to the input voice, obtaining a response to the input voice from each of the plurality of voice assistants.

The providing may include: identifying an accuracy of a response of each voice assistant to the input voice by inputting the response obtained from each of the plurality of voice assistants to an artificial intelligence model trained based on a plurality of questions-responses; and providing a response to the input voice through at least one of the plurality of voice assistants based on the identified accuracy.

The providing may include, providing a response of the identified voice assistant which provided a response with a highest accuracy among the plurality of voice assistants as a response to the input voice.

The providing may include, based on the accuracy of the response of each of the plurality of voice assistants being within a predetermined range, providing a response to the input voice by combining the responses of the plurality of voice assistants.

According to an aspect of the disclosure, there is provided a non-transitory computer-readable medium storing at least one instruction executed by a processor of an electronic apparatus to enable the electronic apparatus to execute operations including: based on a voice of a user being input via a microphone, identifying a voice assistant among a plurality of voice assistants based on the input voice; identifying whether the identified voice assistant is able to provide a response to the input voice, by inputting a text converted from the input voice to an artificial intelligence model trained based on texts recognizable by the identified voice assistant; based on the identified voice assistant being identified to be unable to provide a response to the input voice, obtaining a response to the input voice from at least one of the plurality of voice assistants other than the identified voice assistant; and providing at least one of a plurality of obtained responses as a response to the input voice.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are views for illustrating examples in which an electronic apparatus provides responses using voice assistants selected according to input user's voices according to an embodiment;

FIG. 2A is a block diagram for illustrating a configuration of the electronic apparatus according to an embodiment;

FIG. 2B is a block diagram for illustrating a software configuration of the electronic apparatus according to an embodiment;

FIG. 3 is a view for illustrating an example in which the electronic apparatus selects a voice assistant according to a user command;

FIG. 4A is a block diagram for illustrating an example in which the electronic apparatus selects a voice assistant according to a category of the input user's voice;

FIG. 4B is a view for illustrating mapping information in which a voice assistant is mapped to each category according to an embodiment;

FIG. 5A is a view for illustrating an example embodiment in which the electronic apparatus recognizes a trigger word for a specific voice assistant and selects the corresponding voice assistant;

FIG. 5B is a view for illustrating an example in which the electronic apparatus recognizes a name of a specific voice assistant included in an input user's voice and selects the corresponding voice assistant;

FIG. 6A is a view for illustrating an example in which the electronic apparatus preferentially verifies the selected voice assistant;

FIG. 6B is a view for illustrating an example in which the electronic apparatus identifies a voice assistant which is able to provide a response to a user's voice using a multi-class classifier, if the verification of the selected voice assistant is failed;

FIG. 7 is a view for illustrating an example in which the electronic apparatus provides the most accurate response by determining accuracy of each of a plurality of responses obtained from a plurality of voice assistants;

FIG. 8 is a view for illustrating an example in which the electronic apparatus provides a summary response by combining a plurality of responses obtained from the plurality of voice assistants;

FIG. 9 is a block diagram for illustrating a specific configuration of the electronic apparatus according to embodiments;

FIG. 10 is a view for illustrating an operation of a system including the electronic apparatus and a server according to an embodiment;

FIG. 11 is a flowchart for illustrating a response providing method of the electronic apparatus according to an embodiment;

FIG. 12 is an algorithm flowchart for illustrating a response providing method according to an embodiment;

FIG. 13 is an algorithm flowchart for illustrating a response providing method according to an embodiment; and

FIG. 14 is an algorithm flowchart for illustrating the response providing method according to an embodiment.

### DETAILED DESCRIPTION

The disclosure provides an electronic apparatus which may suitably use a plurality of voice assistants.

The disclosure more particularly provides an electronic apparatus which may verify whether a voice assistant selected by a user is able to provide a suitable response, and, based on the voice assistant being unable to provide a suitable response as a result of the verification, may identify another voice assistant which is able to provide a suitable response.

In addition, the disclosure provides an electronic apparatus which may provide a response with the highest accuracy by determining an accuracy of a response, of each of a plurality of voice assistants, to the input user's voice.

The terms used in the specification and claims have been selected as general terms as much as possible in consideration of functions in the embodiments of the disclosure. But, these terms may vary in accordance with the intention of those skilled in the art, the precedent, technical interpretation, the emergence of new technologies and the like. In addition, there are also terms arbitrarily selected by the Applicant. Such terms may be interpreted as meanings defined in the disclosure and common technical knowledge of the technical field, if, for example, there are no specific term definitions in the disclosure.

The same reference numerals or symbols in the accompanying drawings in the disclosure denote parts or components executing substantially the same function. For convenience of description and understanding, the same reference numerals or symbols are used in different embodiments. That is, although the components with the same reference numerals are illustrated in the plurality of drawings, the plurality of drawings are not illustrating one embodiment.

In addition, terms including ordinals such as “first” or “second” may be used for distinguishing components in the specification and claims. Such ordinals are used for distinguishing the same or similar components and the terms should not be limitedly interpreted due to the use of ordinals. For example, in regard to components with such ordinals, usage order or arrangement order should not be limitedly interpreted with the numbers thereof. The ordinals may be interchanged, if necessary.

Unless otherwise defined specifically, a singular expression may encompass a plural expression. It is to be understood that the terms such as “comprise” or “consist of” are used herein to designate a presence of characteristic, number, step, operation, element, part, or a combination thereof, and not to preclude a presence or a possibility of adding one or more of other characteristics, numbers, steps, operations, elements, parts or a combination thereof.

A term such as “module”, a “unit”, or a “part” in the disclosure is for designating a component executing at least one function or operation, and such a component may be implemented as hardware, software, or a combination of hardware and software. Further, except for when each of a plurality of “modules”, “units”, “parts” and the like needs to be realized in an individual specific hardware, the components may be integrated in at least one module or chip and be implemented in at least one processor.

In addition, in the embodiments of the disclosure, connection of a certain part to another part may include indirect connection via still another medium, and/or direct connection. When it is described that a certain part includes another certain part, it implies that a still another part may be further included, rather than excluding it, unless otherwise noted.

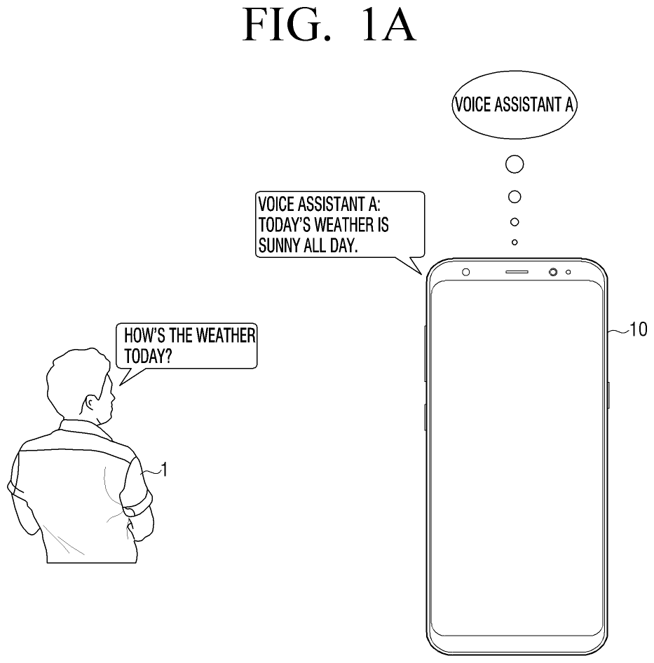

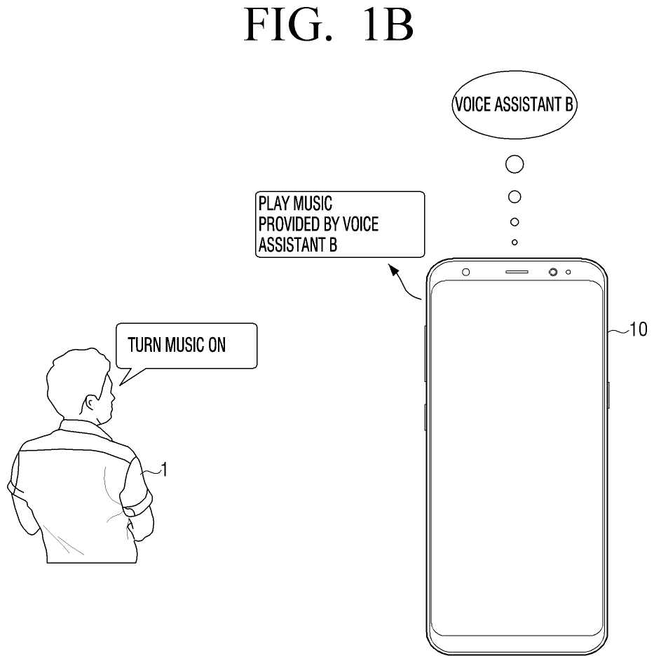

FIG. 1A and 1B are views for illustrating examples in which an electronic apparatus provides (e.g., audibly or visually outputs) a response using a voice assistant selected according to an input user's voice according to an embodiment.

Referring to FIG. 1A, if a voice of a user 1 of “How's the weather today?” is input to an electronic apparatus 10 which may be a smartphone, the electronic apparatus 10 may identify a voice assistant A which is able to provide a response to the weather among a plurality of voice assistants and provide a response such as “Today's weather is sunny all day” through the voice assistant A acoustically via a speaker or an earphone terminal or visually via a display.

Referring to FIG. 1B, if a voice of the user 1 of “Turn music on” is input to the electronic apparatus 10, the electronic apparatus 10 may identify a voice assistant B which is able to provide music among the plurality of voice assistants and output the music provided by the identified voice assistant B via the speaker or the earphone terminal.

As described above, the electronic apparatus according to an embodiment may automatically identify a voice assistant which is able to provide a suitable response to an input user's voice and provide a response through the identified voice assistant. For example, the identified voice assistant may be different from the user-selected voice assistant.

With reference to the following drawings, various embodiments regarding structures and operations of the electronic apparatus will be described in detail below.

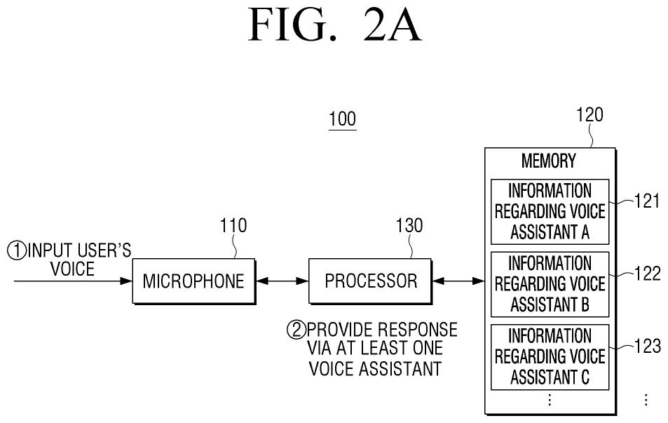

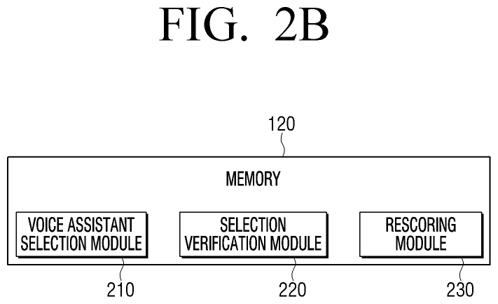

FIG. 2A is a block diagram for illustrating a configuration of the electronic apparatus according to an embodiment.

Referring to FIG. 2A, according to an embodiment, an electronic apparatus 100 may include a microphone 110, a memory 120, and a processor 130. According to example embodiments, the electronic apparatus 100 may correspond to various terminal apparatuses, such as a smartphone, a tablet personal computer (PC), a laptop PC, a desktop PC, a television (TV), a wireless earphone, or the like and the electronic apparatus 100 may also be implemented as various home appliances or a server.

The microphone 110 may be formed of circuitry and may convert an input audio signal into an electric signal. The electronic apparatus 100 may receive a user's voice via the microphone 110.

The memory 120, according to an embodiment, may store an operating system (OS) for controlling general operations of elements of the electronic apparatus 100 and at least one instruction or data related to the elements of the electronic apparatus 100.

The memory 120 may include a non-volatile memory such as a read-only memory (ROM) or a flash memory and may include a volatile memory formed of a dynamic random-access memory (DRAM) or the like. In addition, according to an embodiment, the memory 120 may include a hard disk drive or a solid state drive (SSD).

The memory 120 may store information regarding a plurality of voice assistants which may be used by the electronic apparatus 100 (see e.g., referring to FIG. 2A, information 121 regarding the voice assistant A, information 122 regarding the voice assistant B, information 123 regarding a voice assistant C, and the like). Specifically, the memory 120 may store one or more of: information regarding a name of each of the plurality of voice assistants, an instruction for loading each of the plurality of voice assistants, and/or addresses (e.g., addresses in the memory 120 or in an external server) of software modules forming each of the plurality of voice assistants.

The voice assistant may refer to a virtual entity acoustically providing various services to a user or the service itself. For example, if a question or a command of the user is input in a form of a user's voice or the like, the voice assistant implemented through the electronic apparatus 100 may acoustically provide a response to the user's voice.

According to an embodiment, the voice assistant may include one or more of: a speech recognition module for converting an audio signal into a text (e.g., a natural language), a natural language understanding module for mechanically identifying meaning of the text obtained through the speech recognition module, a question-response module for providing a response to the question, a natural language generation module for generating a natural language corresponding to the identified mechanical meaning, a text-to-speech (TTS) module for converting the generated natural language into an audio signal form, one or more service modules for providing various other services, a database formed of information necessary to provide one or more services, and the like.

Each of the software elements of the voice assistant described above may be stored in the memory 120 of the electronic apparatus 100 or an external server. If at least some of the software elements of the voice assistant are stored in the external server, the service of the voice assistant may be provided through the electronic apparatus based on the communication between the electronic apparatus 100 and the external server.

According to an embodiment, hardware elements, such as the microphone 110 for receiving the user's voice and an output unit (e.g., a speaker, an earphone terminal, a display, and the like) for providing a response while the voice assistant provides the service, may also be included in the voice assistant.

The processor 130 may be connected to the microphone 110, the memory 120, and the like and control the electronic apparatus 100 by executing at least one instruction stored in the memory 120.

For this, the processor 130 may be implemented as a generic-purpose processor, such as a central processing unit (CPU) or an application processor (AP), a graphic dedicated processor such as a vision processing unit (VPU), or an artificial intelligence dedicated processor such as a neural processing unit (NPU). In addition, the processor 130 may include a volatile memory such as an SRAM.

According to an embodiment, the memory 120 and the processor 130 may include a ROM and a random access memory (RAM) and may be implemented in the electronic apparatus 100 to be included in the same chip. In addition, a plurality of chips including different types of processors may be included in the electronic apparatus 100. However, these are merely examples, and physical elements of the memory 120 and the processor 130 in the electronic apparatus 100 are not limited to the examples described above.

If a user's voice is input via the microphone 110, the processor 130 may provide a response to the user's voice via at least one voice assistant among the plurality of voice assistants.

FIG. 2B is a block diagram for illustrating a software configuration of the electronic apparatus according to an embodiment.

Referring to FIG. 2B, the memory 120 may store one or more of: a voice assistant selection module 210, a selection verification module 220, a rescoring module 230, and the like.

These modules may be implemented in terms of software in a ROM of the memory 120 or in a hard disk drive/SSD of the memory 120 and may be executed by the processor 130 in some cases. At least a part of at least one of the modules may be implemented in terms of hardware and, in some cases, at least one of the modules may be implemented with only hardware circuitry.

Specifically, the processor 130 may load the modules 210, 220, and 230 stored in the memory 120 to a RAM (e.g., static RAM (SRAM)) included in the processor 130 and/or a RAM (e.g., DRAM) connected to the processor 130 and execute an instruction corresponding to the modules 210, 220, and 230 according to a determined order.

With reference to the following drawings, operations of the processor 130 using each module, according to various embodiments, will be described in sequence.

If a user's voice is input via the microphone 110, the processor 130 may identify one voice assistant among a plurality of voice assistants based on the input user's voice using the voice assistant selection module 210. The plurality of voice assistants may refer to voice assistants which may be used by the electronic apparatus 100, since relevant information thereof is stored in the memory 120.

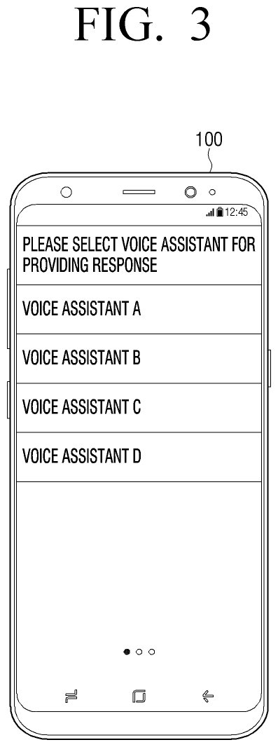

Example embodiments in which the processor 130 identifies one voice assistant among the plurality of voice assistants using the voice assistant selection module 210 is described below, with reference to FIGS. 3, 4A, 4B, 5A, and 5B.

The processor 130 may identify one voice assistant among the plurality of voice assistants according to an input user command. Specifically, the processor 130 may identify a voice assistant selected by the user command.

The user command may be input by various methods, such as touch (touch screen), a voice (microphone 110), a physical button manipulation and/or motion (e.g., via motion detection using a camera).

The user command for selecting the voice assistant may be input before or after a user's voice (e.g., a question) requiring a response is input.

FIG. 3 is a view for illustrating an example in which the electronic apparatus selects one voice assistant among the plurality of voice assistants according to a user command.

Referring to FIG. 3, the electronic apparatus 100 may visually provide a user interface (UI), such as a graphical user interface (GUI), for selecting a voice assistant for providing a response among the plurality of voice assistants. In this case, if touch of the user for selecting any one of voice assistants A to D is input, the electronic apparatus 100 may designate a voice assistant for providing a response as the voice assistant selected by the touch.

The user command for selecting one of the plurality of voice assistants may be input to the electronic apparatus 100 in a state where the user's voice (e.g., a question) requiring a response is already input to the electronic apparatus 100. Alternatively, the user command for selecting one of the plurality of voice assistants may be input to the electronic apparatus 100 in a state where the user's voice requiring a response is not input to the electronic apparatus 100.

If the user's voice is input via the microphone 110, the processor 130 may identify one voice assistant among the plurality of voice assistants based on the input user's voice.

For example, the processor 130 may identify a domain of the input user's voice and identify a predetermined voice assistant for the identified domain. The domain may include a category of a content (text converted from the user's voice) of the input user's voice or a category of a response required according to the input user's voice. The domain may correspond to one or more various categories, such as music, weather, news, sports, and the like.

Specifically, the memory 120 may store information regarding the voice assistant for each of a plurality of domains. The information (e.g., mapping information) regarding the voice assistant for each of the plurality of domains stored in the memory 120 may be generated or updated by a user command.

In this case, the processor 130 may convert the input user's voice into text.

The processor 130 may input the converted text (or information with the text which is mechanically identified) to an artificial intelligence model trained to identify the domain and may identify the domain corresponding to the input user's voice based on output from the artificial intelligence model. The artificial intelligence model may be an artificial intelligence model trained to identify the domain of the input text, based on the information regarding a plurality of texts and a domain of each of the plurality of texts.

The processor 130 may identify a voice assistant corresponding to the identified domain among the plurality of voice assistants based on the information regarding the voice assistant for each of the plurality of domains stored in the memory.

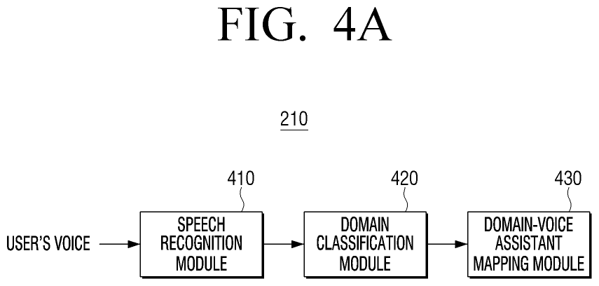

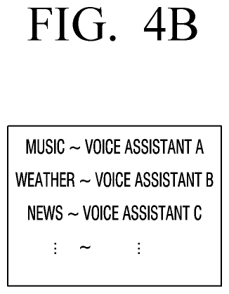

In relation to this, FIG. 4A is a block diagram for illustrating an example in which the electronic apparatus selects a voice assistant according to a category of the input user's voice and FIG. 4B is a view for illustrating an example of mapping information in which a voice assistant is mapped for each category.

Referring to FIG. 4A, the voice assistant selection module 210 may include a speech recognition module 410, a domain classification module 420, a domain-voice assistant mapping module 430, and the like. Each of the modules included in the voice assistant selection module 210 may be executed by the processor 130 in some cases.

Referring to FIG. 4A, based on the user's voice being input (e.g., to a microphone), the speech recognition module 410 may convert the input user's voice into text. The domain classification module 420 may identify a domain of the converted text using an artificial intelligence model trained to identify the domain of the text. The artificial intelligence module may be stored in the memory 120 or an external server.

The domain-voice assistant mapping module 430 may identify a predetermined voice assistant for the identified domain using mapping information as illustrated in FIG. 4B. For example, if a user's voice of “Recommend music” is input, since a domain identified by the domain classification module 420 is “music”, the domain-voice assistant mapping module 430 may identify the voice assistant A according to the mapping information of FIG. 4B.

If a trigger word for activating one voice assistant among the plurality of voice assistants is included in the text converted from the input user's voice, the processor 130 may identify a voice assistant corresponding to the trigger word. The trigger word corresponds to a predetermined command or a “wake-up input” to invoke a voice assistant to receive a service of the corresponding voice assistant.

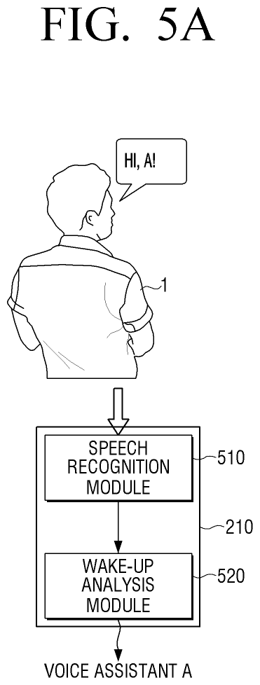

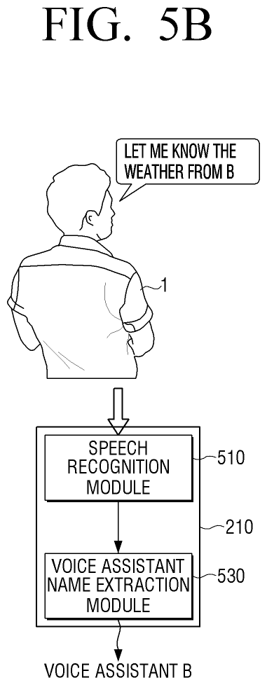

In relation to this, FIG. 5A is a view for illustrating an example in which the electronic apparatus recognizes a trigger word for a specific voice assistant and selects the corresponding voice assistant.

Referring to FIG. 5A, the voice assistant selection module 210 may include a speech recognition module 510 and a wake-up analysis module 520. The wake-up analysis module 520 may determine whether a user's voice is a trigger word by comparing feature information of at least one audio signal generated by utterance of the trigger word of each of the plurality of voice assistants with feature information of an audio signal of the user's voice, or identify a trigger word by analyzing a text converted from the user's voice (or information with text which is mechanically identified).

In FIG. 5A, it is assumed that a trigger word for activating the voice assistant A is “Hi, A”. If a user's voice of “Hi, A” is input and recognized through the speech recognition module 510, the wake-up analysis module 520 may identify “Hi, A” included in the user's voice. In this case, the voice assistant selection module 210 may identify the voice assistant A corresponding to “Hi, A”.

If the input user's voice includes a name of any one voice assistant among the plurality of voice assistants, the processor 130 may identify the corresponding voice assistant.

In relation to this, FIG. 5B is a view for illustrating an example in which the electronic apparatus recognizes a name of a specific voice assistant included in an input user's voice and selects the corresponding voice assistant. Referring to FIG. 5B, the voice assistant selection module 210 may include the speech recognition module 510 and a voice assistant name extraction module 530. The voice assistant name extraction module 530 may identify a name of any one of the plurality of voice assistants by analyzing a text converted from the user's voice.

Referring to FIG. 5B, the speech recognition module 510 may obtain a text of “Check the weather from B” by analyzing an input user's voice. The voice assistant name extraction module 520 may identify B which is the name of the voice assistant included in the obtained text.

In this case, the voice assistant selection module 210 may identify the voice assistant B.

In the embodiments, if any one voice assistant is identified among the plurality of voice assistants, the processor 130 may determine whether the identified voice assistant is able to provide a response to the input user's voice using the selection verification module 220.

The selection verification module 220 may determine response providing possibility of each of the plurality of voice assistants for the input user's voice.

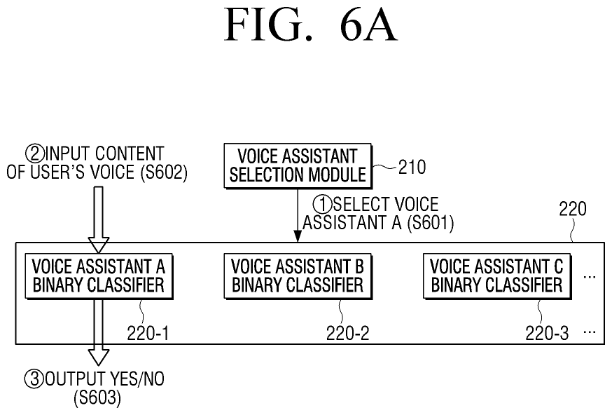

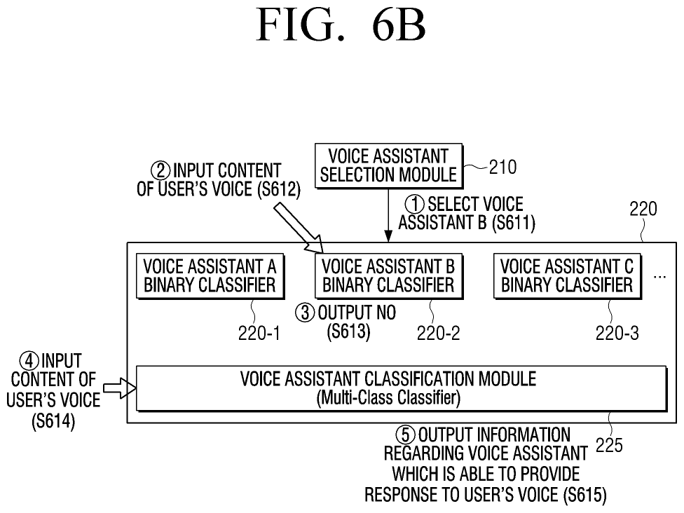

For example, referring to FIG. 6A, the selection verification module 220 may include a binary classifier 220-1 for determining response providing possibility of the voice assistant A, a binary classifier 220-2 for determining response providing possibility of the voice assistant B, a binary classifier 220-3 for determining response providing possibility of the voice assistant C, and the like.

The binary classifier 220-1 will be described as an example among the binary classifiers described above. If a content (text or information with text which is mechanically identified) of the user's voice is input, the binary classifier 220-1 may determine whether the voice assistant A is able to provide a response to the input user's voice.

For this, the binary classifier 220-1 may include an artificial intelligence model trained to determine whether (Yes or No) the voice assistant A is able to provide a response to an input text based on a plurality of texts which are recognizable by the voice assistant A, when the text is input. Specifically, the artificial intelligence model may be trained based on a plurality of texts which are recognizable by the voice assistant A and responses of which are also able to be provided by the voice assistant A. The plurality of texts which are recognizable by the voice assistant A and/or the plurality of texts, responses of which are able to be provided by the voice assistant A may be received from an external (service) server providing the service of the voice assistant A to the electronic apparatus 100 or may be predetermined by a plurality of testers. In addition, if there is a history that a user made “utterance including the name A and a question” (e.g., Let me know how old the president of South Korea is from A) in advance, the processor 130 may identify the corresponding question (e.g., Let me know how old the president of South Korea is) as a text which is able to be responded by the voice assistant A according to the history of the input user's voices, and may use this for training of the artificial intelligence model.

For example, if a specific text of “How's the weather today?” or a text of “The weather today?” similar thereto which is recognizable by the voice assistant A and a response of which is also able to be provided, is input to the artificial intelligence model, a probability of output from the artificial intelligence model (e.g., probability that the voice assistant A is able to provide a response to the corresponding text) may be higher than a threshold value.

The processor 130 may input the text converted from the input user's voice to an artificial intelligence model trained based on texts recognizable by the identified voice assistant, and identify whether the identified voice assistant is able to provide a response to the input user's voice.

Referring to FIG. 6A, if the voice assistant A is identified by the voice assistant selection module 210 (S601), the selection verification module 220 may input a content (text) of the user's voice to the binary classifier 220-1 of the voice assistant A (S602). The selection verification module 220 may determine whether (Yes or No) the voice assistant A is able to provide a response to the input user's voice based on the output of the binary classifier 220-1 (S603). In this case, “Yes or No” may be determined according to whether the output of the artificial intelligence model in the binary classifier 220-1 is a threshold value or more.

As a result of the verification of the voice assistant A, if the voice assistant A is identified to be able to provide the response to the input user's voice, the processor 130 may provide a response to the input user's voice using the voice assistant A.

As a result of the verification of the voice assistant A, if the voice assistant A is identified to be unable to provide the response to the input user's voice, the processor 130 may end the verification process using the selection verification module 220 and may be operated using the rescoring module 230.

In addition, if the voice assistant A is identified to be unable to provide the response to the input user's voice, the processor 130 may not end the verification process immediately and may perform the verification of other voice assistants B, C, and the like in sequence.

In other words, if the identified voice assistant is identified to be unable to provide the response to the input user's voice, the processor 130 may input the text converted from the input user's voice to an artificial intelligence model trained based on texts which are recognizable by another voice assistant among the plurality of voice assistants, and identify whether the other voice assistant is able to provide the response to the input user voice.

For example, if the voice assistant A is identified to be unable to provide the response to the input user's voice (S603—No), the processor 130 may input a content of the user's voice to the binary classifier 220-2 of the voice assistant B, and determine whether the voice assistant B is able to provide the response to the input user's voice.

If the voice assistant B is determined to be able to provide the response to the input user's voice, the processor 130 may provide the response to the user's voice through the voice assistant B. If the voice assistant B is determined to be unable to provide the response to the input user's voice, the processor 130 may input the content of the user's voice to the binary classifier of another voice assistant other than A and B (e.g., binary classifier 220-3 of the voice assistant C).

The processor 130 may determine the voice assistant which is able to provide the response to the input user's voice by verifying one or more voice assistants in sequence by such a method. However, if all binary classifiers included in the selection verification module 220 output “No”, in other words, if it is determined that all of the plurality of voice assistants are unable to provide the response to the input user's voice, the processor 130 may end the verification process through the selection verification module 220 and may be operated using the rescoring module 230.

If the identified voice assistant is identified to be unable to provide the response to the input user's voice, the processor 130 may input the text converted from the input user's voice to an artificial intelligence model trained based on texts which are recognizable by the plurality of voice assistants, and identify the voice assistant which is able to provide the response to the input user's voice among the plurality of voice assistants.

For example, referring to FIG. 6B, the selection verification module 220 may additionally include a voice assistant classification module (multi-class classifier) 225, in addition to the binary classifiers 220-1, 220-2, 220-3, . . . shown in FIG. 6A. The voice assistant classification module 225 may include an artificial intelligence model trained to identify a voice assistant which is able to provide the response to the input text among the plurality of voice assistants, when the text is input. The artificial intelligence model may be trained based on a plurality of texts which are recognizable by a plurality of voice assistants and/or a plurality of texts, responses of which are able to be provided by the plurality of voice assistants, and may be trained to respectively output a probability that each of the plurality of voice assistants is able to provide the response to the input text, when the text is input.

Referring to FIG. 6B, for example, if the voice assistant B is identified by the voice assistant selection module 210 (S611), the selection verification module 220 may input the content of the input user's voice to the binary classifier 220-2 (S612). In this case, if the voice assistant B is identified to be able to provide the response to the input user's voice by the binary classifier 220-2, the response may be provided by the voice assistant B.

If the voice assistant B is identified to be unable to provide the response to the input user's voice (S613), the selection verification module 220 may input the content of the input user's voice to the voice assistant classification module 225 (S614).

The voice assistant classification module 225 may output information regarding the voice assistant corresponding to the highest probability (>threshold value) among the probabilities output by the artificial intelligence model, in other words, information regarding the voice assistant which is able to provide the response to the input user's voice among the plurality of voice assistants (S615). The processor 130 may provide the response to the input user's voice through the voice assistant determined by the voice assistant classification module 225.

For example, if all of the probabilities output by the artificial intelligence model of the voice assistant classification module 225 are less than the threshold value, it is determined that there is no voice assistant which is able to provide the response among the plurality of voice assistants, and accordingly, the processor 130 may end the verification process through the selection verification module 220 and may be operated using the rescoring module 230.

In general, as in FIG. 6B, in a case of selectively performing the binary verification with respect to the identified voice assistant first and then using the voice assistant classification module 225 immediately when the verification is failed, the amount of general operation of the selection verification module 220 may be reduced and a speed of the operation thereof may be comparatively increased, since the verification of the voice assistance identified through the voice assistant selection module 210 may succeed with a high probability.

Although not illustrated in the drawing, the selection verification module 220 may include the voice assistant classification module (multi-class classifier) 225 without including the binary classifiers 220-1, 220-2, and 220-3. In this case, the voice assistant selection module 220 may not be provided in the electronic apparatus 100 either, and if the user's voice is input, the processor 130 may input the content (text) of the input user's voice immediately to the voice assistant classification module 225 and determine the voice assistant which is able to provide the response.

As described in the embodiments described above, if the verification process through the selection verification module 220 ends in a state where the voice assistant which is able to provide the response to the input user's voice has not been determined, the processor 130 may search for the voice assistant for providing the response using the rescoring module 230.

The processor 130 may obtain a response to the input user's voice from each of the plurality of voice assistants using the rescoring module 230. The processor 130 may provide at least one among a plurality of obtained responses as the response to the input user's voice.

The processor 130 may input the response obtained from each of the plurality of voice assistants to an artificial intelligence model trained based on the a plurality of questions and responses, and identify an accuracy of the response of each voice assistant to the input user's voice. The artificial intelligence model may be trained based on a plurality of questions and appropriate responses to the plurality of questions, respectively, but may also be trained based on inappropriate responses (e.g., response not related to the question, response such as “I don't know”, and the like). In addition, the artificial intelligence model may be trained based on responses with comparatively sufficient contents, but may also be trained based on responses with comparatively insufficient contents. Meanwhile, a situation in which questions recognizable by a specific voice assistant among the plurality of voice assistants are mainly used, or the like should be avoided in the training process of the artificial intelligence model. This is because the artificial intelligence model may output a result biased due to the responses of the specific voice assistant when determining the accuracy.

The processor 130 may input the content (text or information with text which is mechanically identified) of the input user's voice and the response obtained from each of the plurality of voice assistants to the artificial intelligence model. As a result, the artificial intelligence model may output the accuracy of the response of each of the plurality of voice assistants to the input user's voice. The output accuracy may be a result reflecting suitability, specificity, and the like of the response to the question.

The processor 130 may provide a response to the input user's voice through at least one of the plurality of voice assistants based on the identified accuracy.

Specifically, the processor 130 may provide the response of the identified voice assistant which has provided the response with the highest accuracy among the plurality of voice assistants, as the response to the input user's voice.

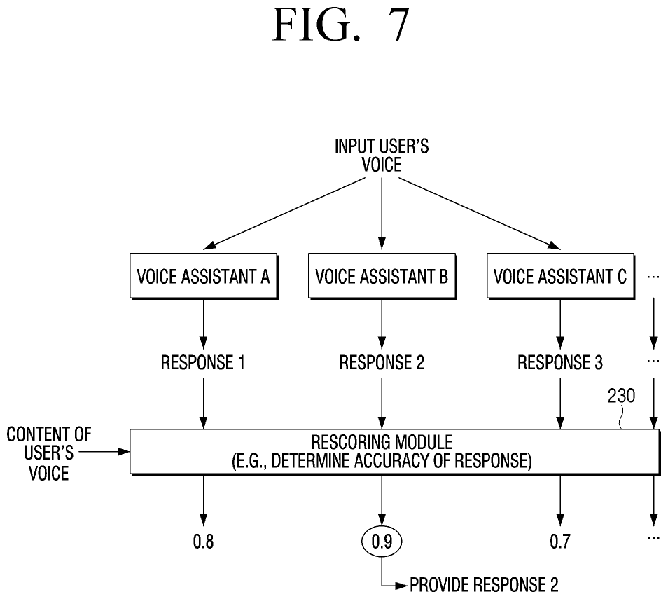

FIG. 7 is a view for illustrating an example in which the electronic apparatus provides the most accurate response by determining the accuracy of each of a plurality of responses obtained from a plurality of voice assistants.

Referring to FIG. 7, the processor 130 may obtain a response 1, a response 2, and a response 3 of the voice assistants A, B, and C to the input user's voice. The processor 130 may obtain an accuracy (e.g., 0.8) of the response 1 to the user's voice by inputting the content of the user's voice and the response 1 to the rescoring module 230. In the same manner, the processor 130 may obtain each of an accuracy (e.g., 0.9) of the response 2 to the user's voice and an accuracy (e.g., 0.7) of the response 3.

As a result, the processor 130 may provide the response 2 of the voice assistant B with the highest accuracy (e.g., 0.9) as the response to the input user's voice.

The processor 130 may determine the text converted from the input user's voice as the text recognizable by the voice assistant which has provided the response with the highest accuracy, and update the artificial intelligence model trained based on the text recognizable by the voice assistant based on the determined text.

For example, as illustrated in FIG. 7, if the response of the voice assistant B is determined to be most accurate through the rescoring module 230, the processor 130 may identify the text converted from the input user's voice as the text recognizable by the voice assistant B, and update the selection verification module 220 using the text. Specifically, if the selection verification module 220 is implemented as illustrated in FIG. 6A, the artificial intelligence model of the binary classifier 220-2 may be trained through the text. If the selection verification module 220 is implemented as illustrated in FIG. 6B, the artificial intelligence model of the binary classifier 220-2 and/or the voice assistant classification module 225 may be trained through the text.

As a result, if a user's voice having the same content is input in the future, the processor 130 may determine the voice assistant B as a voice assistant which is able to provide a response to the user's voice through the selection verification module 220. The processor 130 may provide a response through the voice assistant B without the process illustrated in FIG. 7.

As a result of the response with the highest accuracy, if a user command for giving a negative feedback to the response or requesting for another response is input, the processor 130 may provide the response of the voice assistant with the second highest accuracy to the user.

The processor 130 may provide the response by combining all of the plurality of responses obtained from the plurality of voice assistants. Specifically, if a user command for requesting for summary is input or the accuracy of each of the responses determined through the rescoring module 230 is within a predetermined range (e.g., if the accuracy of all of the determined responses is equal to or more than a predetermined value which is greater than the threshold value, or less than the threshold value), the processor 130 may provide a response obtained by combining and/or summarizing the plurality of responses obtained from the plurality of voice assistants as the response to the input user's voice.

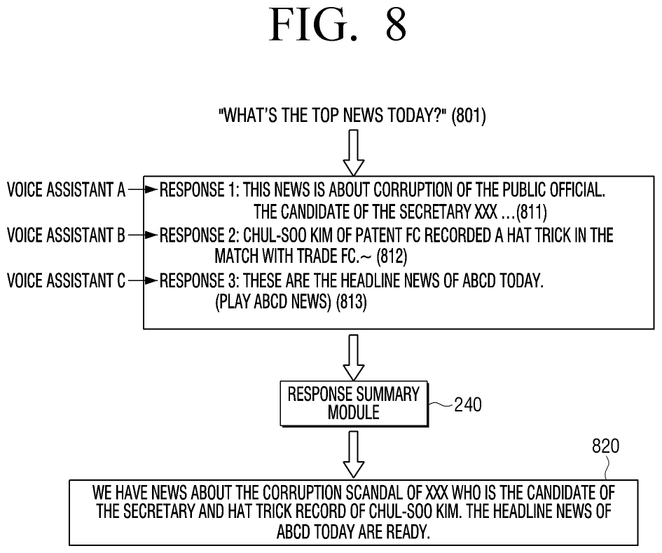

FIG. 8 is a view for illustrating an example in which the electronic apparatus provides a summary response by combining a plurality of responses obtained from the plurality of voice assistants. Referring to FIG. 8, the electronic apparatus 100 includes a response summary module 240 for summarizing the plurality of responses. If a plurality of sentences are input, the response summary module 240 may user an artificial intelligence model trained to provide a summarized text or various well-known document summary algorithms or templates.

In FIG. 8, it is assumed that a user's voice with the content such as “What's the top news today” 801 is input and then a user command for summarizing a plurality of responses obtained from a plurality of voice assistants is additionally input.

Referring to FIG. 8, the response summary module 240 may obtain a new response 820 by combining responses (responses 1, 2, and 3) of voice assistants A to C. The processor 130 may provide the response 820 as a response to the user's voice.

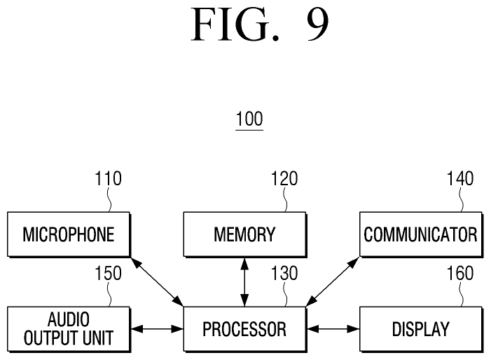

FIG. 9 is a block diagram for illustrating a specific configuration of the electronic apparatus according to embodiments.

Referring to FIG. 9, the electronic apparatus 100 may further include a communicator 140, an audio output unit 150, a display 160, and the like, in addition to the microphone 110, the memory 120, and the processor 130.

The communicator 140 is an element for transmitting and receiving signal/data by communication of the electronic apparatus 100 with at least one external apparatus. For this, the communicator 140 may include circuitry.

The communicator 140 may include a wireless communication module, a wired communication module, and the like.

The wireless communication module may include at least one of a Wi-Fi communication module, a Bluetooth module, an infrared (IrDA, infrared data association) module, a 3rd generation (3G) mobile communication module, 4th generation (4G) mobile communication module, a long term evolution (LTE) mobile communication module, and 5th generation (5G) mobile communication module, to receive a content from an external server or an external apparatus.

The wired communication module may be implemented as a wired port such as a Thunderbolt port or a USB port.

The electronic apparatus 100 may be connected to at least one external server via the communicator 140 and provide services of the plurality of voice assistants. In this case, software modules configuring at least a part of each of the plurality of voice assistants may be stored in the external server.

The electronic apparatus 100 may receive a control signal according to a user command for controlling the electronic apparatus 100 from an external control device through the communicator 140 and perform the operation according to the received control signal. The electronic apparatus 100 may receive the control signal according to the user command input to the external control device from the external control device implemented as a smartphone installed with a remote control application or a remote controller, and provide a response using at least one voice assistant according to the received control signal.

The audio output unit 150 is an element for acoustically providing a response of at least one of the plurality of voice assistants. The audio output unit 150 may be an element such as a speaker, audio/headphone terminals, and the like.

The display 160 is an element for the electronic apparatus 100 to visually provide a response of at least one of the plurality of voice assistants. The electronic apparatus 100 may include one or more displays 160 and may display the response to the input user's voice via the display 160.

The display 160 may be implemented as a liquid crystal display (LCD), a plasma display panel (PDP), an organic light emitting diode (OLED), a transparent OLED (TOLED), a micro LED, or the like.

The display 160 may be implemented in a form of a touch screen which is able to detect touch manipulation of the user or may be implemented as a flexible display which may be bent or warped.

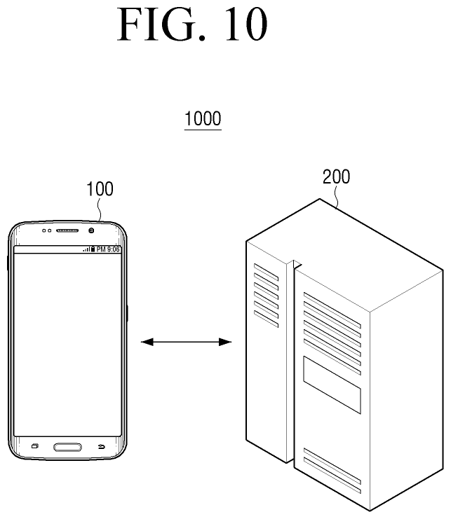

Referring to FIG. 10, the electronic apparatus 100 may be connected to an external server 200 via the communicator 140 to form a system 1000. In FIG. 10, only the server 200 implemented as one apparatus has been descried, but the system 1000 may include a plurality of server apparatuses.

In this case, some of the voice assistant selection module 210, the selection verification module 220, and the rescoring module 230 may be stored in the electronic apparatus 100 and the others thereof may be stored in the external server 200. The system 1000 including the electronic apparatus 100 and the external server 200 may select any one of a plurality of voice assistants, verify this, and determine accuracy of each response of the plurality of voice assistants.

For example, it is assumed that the voice assistant selection module 210 and the selection verification module 220 are stored in the electronic apparatus 100 and the rescoring module 230 is stored in the server 200. If the electronic apparatus 100 is not able to identify the voice assistant which is able to provide the response to the (input) user's voice through the selection verification module 220, the electronic apparatus 100 may transmit a signal for activating the rescoring module 230 and information regarding the input user's voice to the server 200. The server 200 may obtain a response of a voice assistant providing the most accurate response through the rescoring module 230 and transmit the information regarding the obtained response to the electronic apparatus 100. As a result, the electronic apparatus 100 may visually/acoustically provide the received response.

However, there is no limitation to this example, and various embodiments in which the electronic apparatus 100 and the external server 200 are connected and operated may be realized.

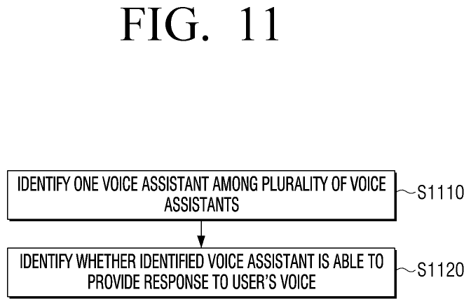

Hereinafter, embodiments of a response providing method of the electronic apparatus according to the disclosure will be described with reference to FIGS. 11 to 14.

FIG. 11 is a flowchart for illustrating a response providing method of the electronic apparatus according to an embodiment.

Referring to FIG. 11, the response providing method may include, based on a user's voice being input via a microphone, identifying one voice assistant among a plurality of voice assistants (S1110). The plurality of voice assistants may be voice assistants which may be used by the electronic apparatus 100. In other words, the electronic apparatus 100 may provide a service provided through each of the plurality of voice assistants. For this, each of hardware/software configurations configuring each of the plurality of voice assistants may be stored in the electronic apparatus 100 and/or an external server that is able to communicate with the electronic apparatus 100.

In this case, a voice assistant selected according to a user command (e.g., various methods such as touch, motion, voice, and the like) may be identified among the plurality of voice assistants.

In addition, one voice assistant may be identified among the plurality of voice assistants based on the input user's voice.

For example, if a text converted from the input user's voice includes a trigger word for activating one voice assistant among the plurality of voice assistants, a voice assistant corresponding to the trigger word may be identified.

In another example, the text converted from the input user's voice may be input to an artificial intelligence model trained to determine a domain of the input text among a plurality of domains, to identify the domain corresponding to the input user's voice, and to identify a voice assistant corresponding to the identified domain among the plurality of voice assistants. Predetermined mapping information in which the plurality of voice assistants are mapped to the plurality of domains may be used.

The response providing method may include identifying whether the identified voice assistant is able to provide a response to the input user's voice (S1120).

Specifically, it may be identified whether the identified voice assistant is able to provide a response to the input user's voice, using information output as a result of input of the text converted from the input user's voice to an artificial intelligence model trained based on texts recognizable by the identified voice assistant. For this, the electronic apparatus may store artificial intelligence model trained based on texts recognizable by each of the plurality of voice assistants.

If it is determined that the identified voice assistant is able to provide a response to the input user's voice, the response to the input user's voice may be provided using the identified voice assistant.

If it is identified that the identified voice assistant is unable to provide the response to the user's voice, a response to the input user's voice is obtained from each of the plurality of voice assistants, and at least one of the plurality of obtained responses may be provided as a response to the input user's voice.

For example, if it is identified that the identified voice assistant is unable to provide the response to the user's voice, a response may be obtained immediately from each of the plurality of voice assistants.

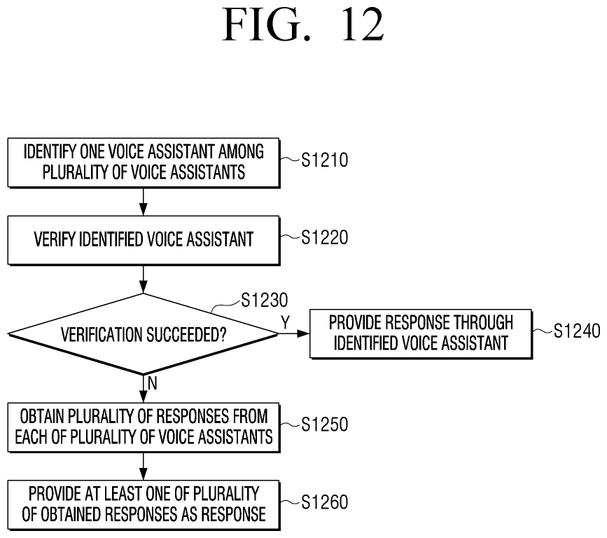

In relation to this, FIG. 12 is an algorithm flowchart for illustrating an example of the response providing method according to an embodiment.

Referring to FIG. 12, the response providing method may include identifying one voice assistant among a plurality of voice assistants as in Step S1110 described above (S1210). As in Step S1120, it may be verified whether the identified voice assistant is able to provide a response to the input user's voice (S1220).

As a result of the verification, if it is identified that the identified voice assistant is able to provide a response to the input user's voice (S1230—Y), the response may be provided through the identified voice assistant (S1240). On the other hand, as a result of the verification, if it is identified that the identified voice assistant is unable to provide a response to the input user's voice (S1230—N), a plurality of responses may be obtained from the plurality of voice assistants, respectively (S1250). At least one of the plurality of obtained responses may be provided as the response (S1260).

The obtained responses obtained from the plurality of voice assistants respectively may be input to an artificial intelligence model trained based on questions-responses, accuracy of the response of each voice assistant to the input user's voice may be identified, and the response to the input user's voice may be provided through at least one of the plurality of voice assistants based on the identified accuracy.

Specifically, the response of the identified voice assistant which has provided the response with the highest accuracy among the plurality of voice assistants may be provided as the response to the input user's voice.

If it is identified that the identified voice assistant is unable to provide the response to the input user's voice through Step S1110, unlike FIG. 12, the text converted from the input user's voice may be input to an artificial intelligence model trained based on texts recognizable by another voice assistant among the plurality of voice assistants, and it may be identified whether the other voice assistant is able to provide a response to the input user's voice.

If it is identified that the other voice assistant is able to provide the response to the input user's voice, the response may be provided through the other voice assistant.

On the other hand, if it is identified that the other voice assistant is unable to provide the response to the input user's voice, either, a response to the input user's voice may be obtained from each of the plurality of voice assistants and at least one response may be provided among the obtained responses.

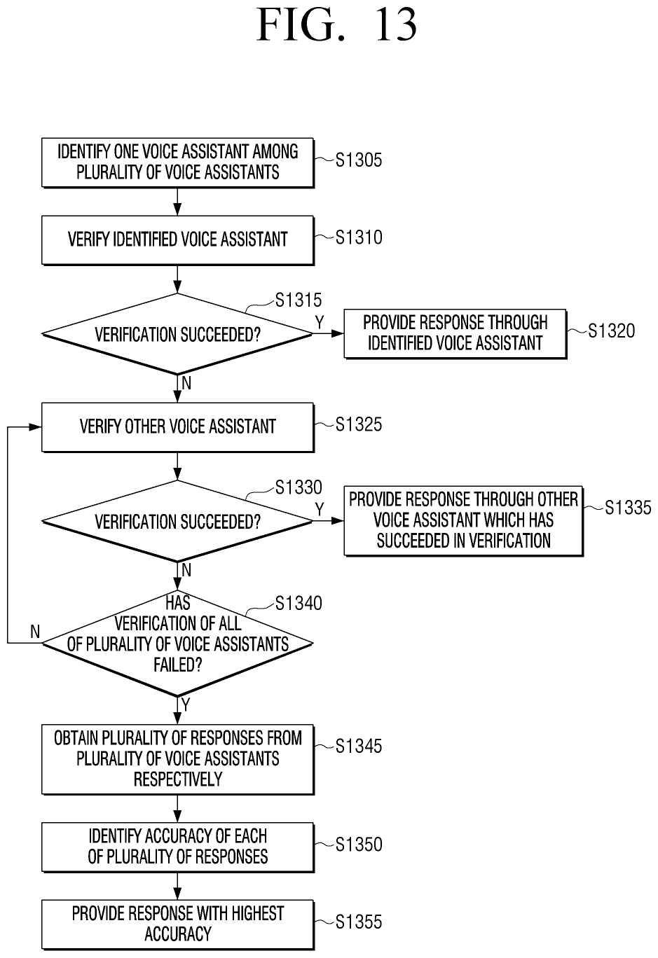

In relation to this, FIG. 13 is an algorithm flowchart for illustrating the response providing method according to an embodiment.

Referring to FIG. 13, if it is identified that the identified voice assistant is unable to provide a response to the input user's voice through Steps S1305 to S1310 (S1315—N), the response providing method may include verifying whether another voice assistant among the plurality of voice assistants is able to provide a response to the input user's voice (S1325). If the verification succeeds (S1330—Y), the response may be provided through the other voice assistant (S1335).

If the verification fails (S1330—N), still another voice assistant may be verified (S1340—N, S1325). If the verification of the still another voice assistant succeeds, the response may be provided through the corresponding voice assistant.

If no voice assistant which is able to provide the response to the input user's voice is identified, even if the verification is performed with respect to all of the plurality of voice assistants (S1340—Y), the response providing method may include obtaining a plurality of responses from the plurality of voice assistants respectively by transferring the input user's voice to the plurality of voice assistants (S1345).

In this case, an accuracy of each of the plurality of responses may be determined (S1350) and a response of a voice assistant which has provided a response with the highest accuracy may be provided as the response to the input user's voice (S1355).

If it is identified that the identified voice assistant is unable to provide the response to the input user's voice through Step S1110, unlike FIGS. 12 and 13, the text converted from the input user's voice may be input to an artificial intelligence model trained based on texts recognizable by the plurality of voice assistants, and a voice assistant which is able to provide the response to the input user's voice may be identified among the plurality of voice assistants. In this case, the response to the input user's voice may be provided through a voice assistant identified to be able to provide the response.

However, if the voice assistant which is able to provide the response is not identified among the plurality of voice assistants, a response to the input user's voice is obtained from each of the plurality of voice assistants, and at least one response may be provided among the obtained responses.

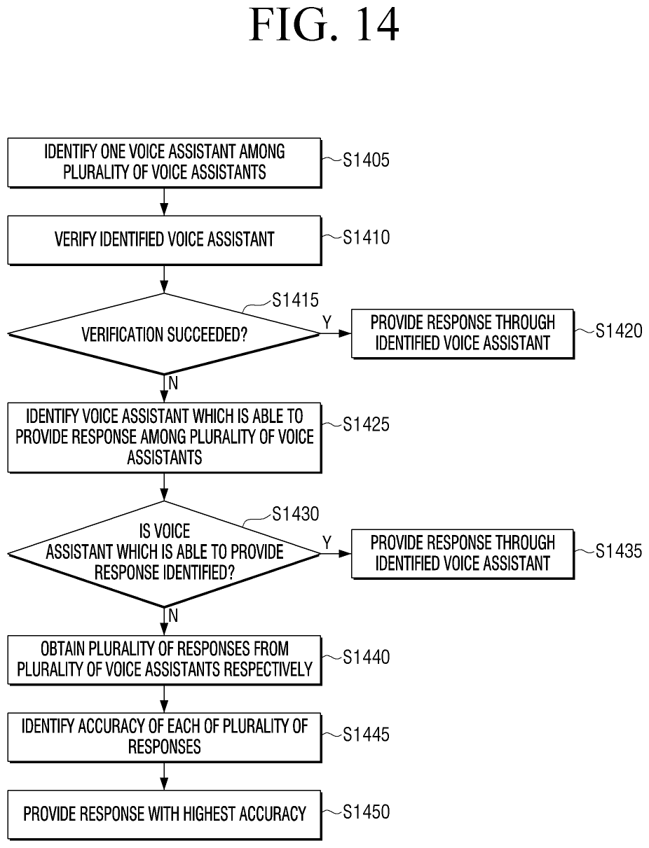

In relation to this, FIG. 14 is an algorithm flowchart for illustrating the response providing method according to an embodiment.

Referring to FIG. 14, if it is identified that the identified voice assistant is unable to provide the response to the input user's voice as a result of Steps S1405 and S1410 (S1415—N), the response providing method may include determining a voice assistant which is able to provide a response among the plurality of voice assistants (S1425). In this case, an artificial intelligence trained to determine a voice assistant which is able to provide the response to input information among the plurality of voice assistants, if information regarding an audio signal of a voice or information regarding a text corresponding to the voice is input, may be used.

If a voice assistant which is able to provide the response to the input user's voice is identified as a result of Step S1425 (S1430—Y), the response may be provided through the identified voice assistant (S1435).

On the other hand, if the voice assistant which is able to provide the response to the input user's voice is not identified (S1430—N), a plurality of responses may be obtained from the plurality of voice assistants, respectively (S1440), an accuracy of each of the plurality of responses may be determined (S1445), and a response with the highest accuracy may be provided (S1450).

In the embodiments of the response providing method described above, if the accuracy of the response of each of the plurality of voice assistants is within a predetermined range (e.g., if the accuracy of all responses is less than a threshold value), a response to the input user's voice may be provided by combining responses of the plurality of voice assistants. A response obtained by summarizing the plurality of responses obtained from the plurality of voice assistants may be provided.

The response providing method of the electronic apparatus described with reference to FIGS. 11 to 14 may be implemented through the electronic apparatus 100 illustrated and described with reference to FIGS. 2 and 9 or the system 1000 illustrated and described with reference to FIG. 10.

The electronic apparatus according to the disclosure may exhibit an effect of identifying a voice assistant which is able to provide the most suitable response to the input user's voice among the plurality of usable voice assistants and selectively providing a response of the corresponding voice assistant.

The electronic apparatus according to the disclosure may exhibit an effect of preferentially determining a response providing possibility to a voice assistant selected/designated by a user and minimizing and/or reducing an amount of operation(s) of a process of determining a voice assistant for providing a response among the plurality of voice assistants.

The electronic apparatus according to the disclosure exhibits an effect of selectively providing only a response with the highest accuracy among responses provided by the plurality of voice assistants to the input user's voice.

The embodiments described above may be implemented in a recording medium readable by a computer or a similar device using software, hardware, or a combination thereof.

According to the implementation in terms of hardware, the embodiments of the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions. In some cases, the embodiments described in this specification may be implemented as the processor 130 itself. According to the implementation in terms of software, the embodiments such as procedures and functions described in this specification may be implemented as separate software modules. Each of the software modules may perform one or more functions and operations described in this specification.

Computer instructions for executing processing operations in the electronic apparatus 100 according to the embodiments of the disclosure descried above may be stored in a non-transitory computer-readable medium. When the computer instructions stored in such a non-transitory computer-readable medium are executed by the processor of a specific machine, the computer instructions may enable a specific machine to execute the processing operations of the electronic apparatus 100 according to the embodiments described above.

The non-transitory computer-readable medium is not a medium storing data for a short period of time such as a register, a cache, or a memory, but means a medium that semi-permanently stores data and is readable by a machine. Specifically, the various applications or programs described above may be stored and provided to the non-transitory computer-readable medium such as a compact disc (CD), a digital versatile disc (DVD), a hard disk drive, a Blu-ray disc, a universal serial bus (USB), a memory card, and a ROM.

While preferred embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic apparatus comprising:
a memory configured to store information regarding a plurality of voice assistants; and
a processor configured to:
based on an input voice of a user being received via a microphone, identify a voice assistant among the plurality of voice assistants based on the input voice;
identify whether the identified voice assistant is able to provide a response to the input voice, by inputting a text converted from the input voice to an artificial intelligence model trained based on texts recognizable by the identified voice assistant;
based on the identified voice assistant being identified to be unable to provide a response to the input voice, obtain a response to the input voice from at least one of the plurality of voice assistants other than the identified voice assistant; and
provide at least one of a plurality of obtained responses as a response to the input voice.

2. The electronic apparatus according to claim 1, wherein the processor is further configured to, based on the text converted from the input voice including a trigger word for activating the voice assistant among the plurality of voice assistants, identify the voice assistant corresponding to the trigger word.

3. The electronic apparatus according to claim 1, wherein the memory is further configured to store information regarding the voice assistant for each of a plurality of domains, and
wherein the processor is further configured to:
identify a domain corresponding to the input voice by inputting the text converted from the input voice to an artificial intelligence model trained to determine a domain of an input text among the plurality of domains; and
identify the voice assistant corresponding to the identified domain among the plurality of voice assistants based on the information stored in the memory.

4. The electronic apparatus according to claim 1, wherein the processor is further configured to, based on the identified voice assistant being identified to be able to provide a response to the input voice, provide a response to the input voice using the identified voice assistant.

5. The electronic apparatus according to claim 1, wherein the processor is further configured to:
based on the identified voice assistant being identified to be unable to provide a response to the input voice, identify whether another voice assistant is able to provide a response to the input voice, by inputting the text converted from the input voice to another artificial intelligence model that has been trained based on texts recognizable by the other voice assistant among the plurality of voice assistants; and
based on the other voice assistant being identified to be unable to provide a response to the input voice, obtain a response to the input voice from each of the plurality of voice assistants.

6. The electronic apparatus according to claim 1, wherein the processor is further configured to:
based on the identified voice assistant being identified to be unable to provide a response to the input voice, identify a voice assistant which is able to provide a response to the input voice, from among the plurality of voice assistants, by inputting the text converted from the input voice to an artificial intelligence model that is trained based on texts recognizable by the plurality of voice assistants; and
based on none of the plurality of voice assistants being identified to be able to provide a response to the input voice, obtain a response to the input voice from each of the plurality of voice assistants.

7. The electronic apparatus according to claim 1, wherein the processor is further configured to:
identify an accuracy of a response of each voice assistant to the input voice by inputting the response obtained from each of the plurality of voice assistants to an artificial intelligence model trained based on a plurality of questions-responses; and
provide a response to the input voice through at least one of the plurality of voice assistants based on the identified accuracy.

8. The electronic apparatus according to claim 7, wherein the processor is further configured to provide a response of the identified voice assistant which provided a response with a highest accuracy among the plurality of voice assistants as a response to the input voice.

9. The electronic apparatus according to claim 7, wherein the processor is further configured to, based on the accuracy of the response of each of the plurality of voice assistants being within a predetermined range, provide a response to the input voice by combining the responses of the plurality of voice assistants.

10. The electronic apparatus according to claim 7, wherein the processor is further configured to:
determine the text converted from the input voice as a text recognizable by a voice assistant which provided a response with a highest accuracy; and
update an artificial intelligence model trained based on texts recognizable by the voice assistant based on the determined text.

11. A response providing method of an electronic apparatus, the response providing method comprising:
based on an input voice of a user being received via a microphone, identifying a voice assistant among a plurality of voice assistants based on the input voice;
identifying whether the identified voice assistant is able to provide a response to the input voice, by inputting a text converted from the input voice to an artificial intelligence model trained based on texts recognizable by the identified voice assistant;
based on the identified voice assistant being identified to be unable to provide a response to the input voice, obtaining a response to the input voice from at least one of the plurality of voice assistants other than the identified voice assistant; and
providing at least one of a plurality of obtained responses as a response to the input voice.

12. The response providing method according to claim 11, wherein the identifying the voice assistant comprises, based on the text converted from the input voice including a trigger word for activating the voice assistant among the plurality of voice assistants, identifying the voice assistant corresponding to the trigger word.

13. The response providing method according to claim 11, wherein the identifying the voice assistant comprises:
identifying a domain corresponding to the input voice by inputting the text converted from the input voice to an artificial intelligence model trained to determine a domain of an input text among a plurality of domains; and
identifying the voice assistant corresponding to the identified domain among the plurality of voice assistants.

14. The response providing method according to claim 11, further comprising:
based on the identified voice assistant being identified to be able to provide a response to the input voice, providing a response to the input voice using the identified voice assistant.

15. The response providing method according to claim 11, further comprising:
based on the identified voice assistant being identified to be unable to provide a response to the input voice, identifying whether another voice assistant is able to provide a response to the input voice, by inputting the text converted from the input voice to an artificial intelligence model trained based on texts recognizable by the other voice assistant among the plurality of voice assistants,
wherein the obtaining a response comprises, based on the other voice assistant being identified to be unable to provide a response to the input voice, obtaining a response to the input voice from each of the plurality of voice assistants.

16. The response providing method according to claim 11, further comprising:
based on the identified voice assistant being identified to be unable to provide a response to the input voice, identifying a voice assistant which is able to provide a response to the input voice among the plurality of voice assistants by inputting the text converted from the input voice to an artificial intelligence model trained based on texts recognizable by the plurality of voice assistants,
wherein the obtaining a response comprises, based on none of the plurality of voice assistants being identified to be able to provide a response to the input voice, obtaining a response to the input voice from each of the plurality of voice assistants.

17. The response providing method according to claim 11, the providing comprises:
identifying an accuracy of a response of each voice assistant to the input voice by inputting the response obtained from each of the plurality of voice assistants to an artificial intelligence model trained based on a plurality of questions-responses; and
providing a response to the input voice through at least one of the plurality of voice assistants based on the identified accuracy.

18. The response providing method according to claim 17, wherein the providing comprises, providing a response of the identified voice assistant which provided a response with a highest accuracy among the plurality of voice assistants as a response to the input voice.

19. The response providing method according to claim 17, wherein the providing comprises, based on the accuracy of the response of each of the plurality of voice assistants being within a predetermined range, providing a response to the input voice by combining the responses of the plurality of voice assistants.

20. A non-transitory computer-readable medium storing at least one instruction executed by a processor of an electronic apparatus to enable the electronic apparatus to execute operations comprising:
based on an input voice of a user being received via a microphone, identifying a voice assistant among a plurality of voice assistants based on the input voice;
identifying whether the identified voice assistant is able to provide a response to the input voice, by inputting a text converted from the input voice to an artificial intelligence model trained based on texts recognizable by the identified voice assistant;
based on the identified voice assistant being identified to be unable to provide a response to the input voice, obtaining a response to the input voice from at least one of the plurality of voice assistants other than the identified voice assistant; and
providing at least one of a plurality of obtained responses as a response to the input voice.
